(19) United States
(12) Patent Application Publication
(10) Pub. No.: US 2022/0190944 A1
(43) Pub. Date: Jun. 16, 2022

(54) INFORMATION EMBEDDED METHOD AND SYSTEM

(71) Applicant: Atlanta DTH, Inc., Peachtree Corners, GA (US)

(72) Inventors: Alexander K Day, Atlanta, GA (US); Sang Hoon Kim, Seongnam-si (KR); Lixin Yu, Suwanee, GA (US)

(21) Appl. No.: 17/118,674

(22) Filed: Dec. 11, 2020

(51) Int. Cl. H04H 60/19; H04H 60/20; H04H 20/47; H04N 5/45

(52) U.S. Cl. CPC H04H 60/19; H04N 5/45; H04H 20/47; H04H 60/20

(57) ABSTRACT

An information embedded method is used with a broadcast source and a broadcast signal receiver using a unidirectional transmission medium. The information embedded method includes steps of: storing information-push files in the broadcast signal receiver during a first time period; the broadcast source delivering broadcast signals to the broadcast signal receiver through the unidirectional transmission medium during a second time period posterior to the first time period; and the broadcast signal receiver selecting one of the information-push files according to a predetermined rule and combining the broadcast signals and information content of the selected information-push file to form an information embedded program. An information embedded system includes the broadcast source and the broadcast signal receiver.

### FIELD OF THE INVENTION

The present disclosure relates to an information embedded method and an information embedded system, and particularly to an information embedded method and an information embedded system using a unidirectional transmission medium.

### BACKGROUND OF THE INVENTION

Broadcasting such as radio broadcasting and television broadcasting is a mature technology for a long time and has been widely applied. The basic broadcast distribution is performed by cooperation between transmitters and receivers and comes over the air or through cables in a one-way manner, and the equipment installation is cheap and easy compared with network communication. Therefore, broadcasting is one of the most efficient ways for information distribution in some countries or regions where network construction is not complete and bidirectional communication through the network is not so widespread and even expensive. However, the broadcast content coming from one broadcast service provider and broadcast on one channel is identical for all audiences and can not target different groups. It is desired to providing a more efficient way to broadcast programs with audience-oriented information according to the audience attributes.

### SUMMARY OF THE INVENTION

An aspect of the present disclosure provides an information embedded method used with a broadcast source and a broadcast signal receiver using a unidirectional transmission medium. In the information embedded method, information-push files are stored in the broadcast signal receiver during a first time period. The broadcast source delivers broadcast signals to the broadcast signal receiver through the unidirectional transmission medium during a second time period posterior to the first time period. The broadcast signal receiver selects one of the information-push files according to a predetermined rule and combines the broadcast signals and information content of the selected information-push file to form an information embedded program.

Another aspect of the present disclosure provides an information embedded system. The information embedded system includes a broadcast source and a broadcast signal receiver having a storage device. The broadcast source delivers broadcast signals through a unidirectional transmission medium during a second time period. The broadcast signal receiver receives the broadcast signals through the unidirectional transmission medium, receives and stores information-push files in the storage device of the broadcast signal receiver during a first time period prior to the second time period, selects one of the information-push files according to a predetermined rule, and combines the broadcast signals and information content of the selected information-push file to form an information embedded program.

A further aspect of the present disclosure provides a broadcast playout device with an information-push function. The broadcast playout device includes a storage device, a broadcast signal receiver, a processing unit and an output device. The storage device stories information-push files received during a first time period. The broadcast signal receiver receives broadcast signals from a broadcast source through a unidirectional transmission medium during a second time period posterior to the first time period. The processing unit selects one of the information-push files stored in the storage device according to a predetermined rule and combines the broadcast signals and information content of the selected information-push file to form an information embedded program. The output device receives the information embedded program from the processing unit and reproduces the information embedded program.

A further aspect of the present disclosure provides a broadcast source of an information embedded system. The broadcast source includes a broadcast signal transmitter for delivering broadcast signals and information-push files to a broadcast signal receiver through a unidirectional transmission medium. The information-push files are transmitted to the broadcast signal receiver through an idle channel or a dedicated channel of the unidirectional transmission medium during a first time period; and the broadcast signals are transmitted to the broadcast signal receiver through a broadcast channel of the unidirectional transmission medium during a second time period posterior to the first time period. The broadcast signals comprise insertion splice points or display position for inserting information content of one of the information-push files into broadcast content of the broadcast signals.

A further aspect of the present disclosure provides an information delivery method, used with a broadcast source and a broadcast signal receiver using a unidirectional transmission medium. In the information delivery method, information-push files are stored in the broadcast signal receiver during a first time period. Then, the broadcast source delivers broadcast signals to the broadcast signal receiver through the unidirectional transmission medium during a second time period posterior to the first time period. A portable electronic device can download one of the information-push files from the broadcast signal receiver according to a predetermined rule.

In the information embedded method and the information embedded system according to the present disclosure, the information-push files are previously stored in the broadcast playout device before the broadcast playout device receives the corresponding broadcast signals from the broadcast source. The broadcast playout device can select one information-push file to be combined with the broadcast signals received later according to the audience attributes. Therefore, the broadcast content is not undifferentiated anymore and can target different audience groups even though the transmission mechanism between the broadcast source and the broadcast playout device only supports unidirectional transmission.

### BRIEF DESCRIPTION OF THE DRAWINGS

The advantages of the present disclosure will become more readily apparent to those ordinarily skilled in the art after reviewing the following detailed description and accompanying drawings, in which:

FIG. 1 is a block diagram illustrating an information embedded system according to embodiments of the present disclosure;

FIG. 2 is a flowchart illustrating an information embedded method used with the information embedded system of FIG. 1;

FIG. 3A is a schematic diagram showing a video stream generated by the broadcast signal receiver of the information embedded system;

FIGS. 3B-3D are schematic diagrams showing the advertisements displayed on a TV set in different modes;

FIG. 4 is a block diagram illustrating a broadcast playout device according to an embodiment of the present disclosure;

FIG. 5 is a schematic diagram illustrating the use of a smartphone in the information embedded method and the information embedded system according to an embodiment of the present disclosure;

FIG. 6 is a schematic diagram illustrating the use of a smartphone in the information embedded method and the information embedded system according to another embodiment of the present disclosure; and

FIG. 7 is a schematic diagram illustrating an information embedded system for radio broadcasting according to an embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

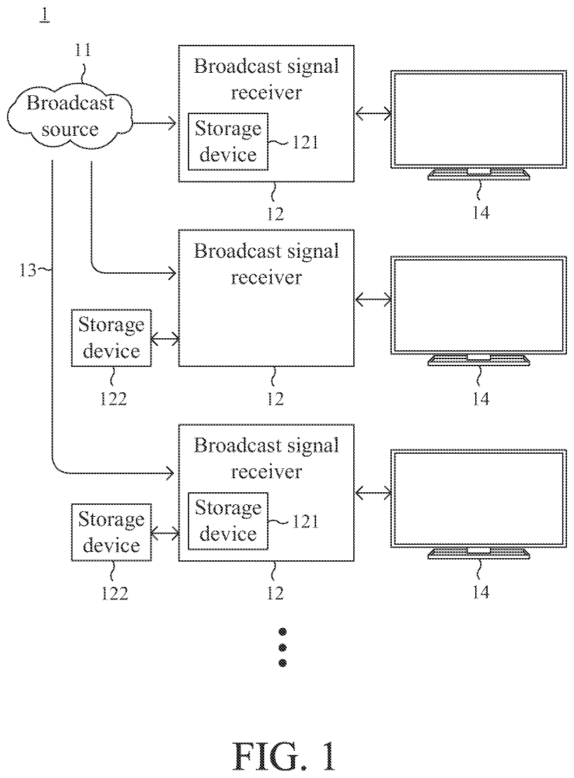

Please refer to FIG. 1, which is a block diagram illustrating an information embedded system according to an embodiment of the present disclosure. The information embedded system 1 includes a broadcast source 11 and broadcast signal receivers 12. The broadcast source 11 transmits broadcast signals to the broadcast signal receivers 12 through a unidirectional transmission medium 13 in a one-to-many manner. For example, the broadcast source 11 is a video program source providing program services for program subscribers. The broadcast signals are issued by a television station of a cable television, a terrestrial television or a satellite television, but the program service providers are not limited to these. The broadcast signal receivers 12 may be set-top boxes (STB) located in respective subscribers' places to convert the broadcast signals into program content that can be displayed on broadcast playout device, e.g. TV sets 14, displays or screens connected to the respective set-top boxes. The unidirectional transmission medium 13 could be implemented by a cable or radio waves.

Since the unidirectional transmission medium 13 can support only unidirectional transmission from the broadcast source 11 to the broadcast signal receivers 12, the audiences can not actively communicate with the broadcast source 11 through the broadcast signal receivers 12. In this situation, the broadcast content, including TV programs and advertisements, on a specific channel are identical for all audiences according to the prior arts.

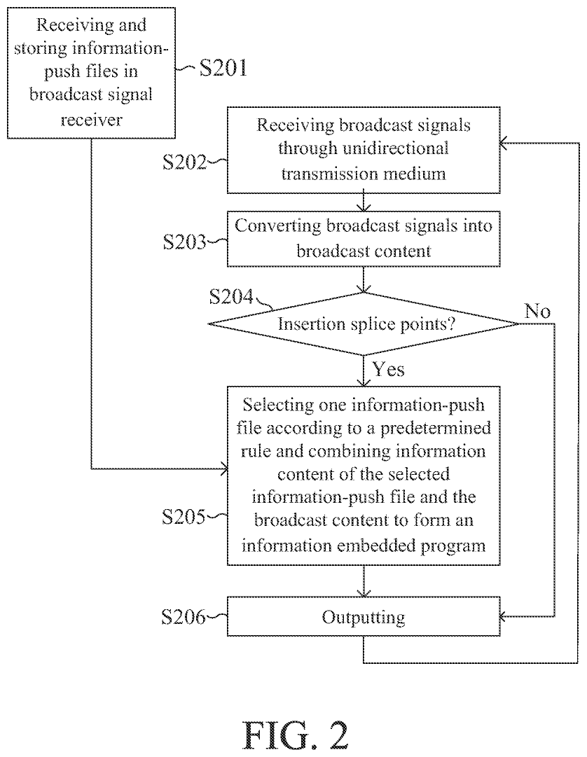

The present disclosure provides an efficient method for providing selective advertisements for different target customers. Please refer to FIG. 2, which is a flowchart illustrating an information embedded method used with the information embedded system of FIG. 1. The broadcast signal receiver 12 receives and stores information-push files during a first time period (step S201), and receives broadcast signals through the unidirectional transmission medium 13 during a second time period posterior to the first time period (step S202). The broadcast signal receiver 12 continuously converts the received broadcast signals into broadcast content to be shown (step S203). When detecting the insertion splice points (step S204), it means that it is the designated time to insert information such as advertisement. The broadcast signal receiver 12 selects one of the information-push files received in step S201 according to a predetermined rule and combines broadcast content of the broadcast signals and information content of the selected information-push file to form an information embedded program (step S205). The information embedded program is outputted (step S206) through an output device such as TV set 14 (step S206). If it is not the designated time for advertisement insertion (step S204), the broadcast content is directly outputted through the output device (step S206). The steps S202˜S206 are repeated to generate a video stream.

For the purpose of illustration and description only, a TV program service provider 11 and a set-top box 12 with signal transmission through one-way radio waves 13 are described in the embodiment. It is to be noted that other types of broadcast sources 11, broadcast signal receivers 12 and unidirectional transmission media 13 are also applicable and can be derived from the following description. At first, the TV program service provider 11 uses a broadcast signal transmitter (not shown) to transmit information-push files representing various types of advertisements to the set-top box 12. The information-push files could be transmitted through an idle channel to avoid signal interference in the broadcast signals transmitted through broadcast channels. Alternatively, a dedicated channel is assigned for the information-push files to ensure safety or security transmission. A multiplexer could be used for controlling the transmission of the broadcast signals to be viewed in a first time period and the information-push files to be viewed in a second time period posterior to the first time period. In other words, the broadcast signals and the information-push files transmitted during the same time period are not shown on TV set 14 at the same time.

Then, the set-top box 12 receives and stores the information-push files in an internal storage device 121. These actions could be done in a background process in a sleep mode or an active mode of the set-top box 12 without affecting the current TV program broadcasting. The attributes of the information-push files may also be recorded in the internal storage device 121 for classification or further reference in the later selection step.

In a working mode, the set-top box 12 continuously receives and converts the broadcast signals issued from the broadcast signal transmitter. At this time, the set-top box 12 selects one information-push file previously stored in the internal storage device 121 according to a predetermined rule, e.g. a playout region, a broadcast time or an audience profile corresponding to the set-top box 12. The information content of the selected information-push file is a preferred advertisement ready for shown. For example, if the set-top box 12 is located in a region A, an advertisement for restaurants or branch stores in the region A is a better choice. Further, suppose the broadcast time is in regular working hours on a working day. In that case, it could be predicted that the primary audiences are housekeepers, and an advertisement for clothing or household goods is preferred. Furthermore, if an audience profile is obtained in advance, the selection of the advertisement could be made according to the audience profile. The audience profile could be obtained through questionnaires for the program subscribers to realize the age-sex composition of audiences in the place during different time periods or which kinds of commercial goods or services they are interested in. Alternatively, the audience profile could be determined according to the channel selection actions recorded in the set-top box 12. Therefore, regional and individual advertising to different target audiences can be achieved.

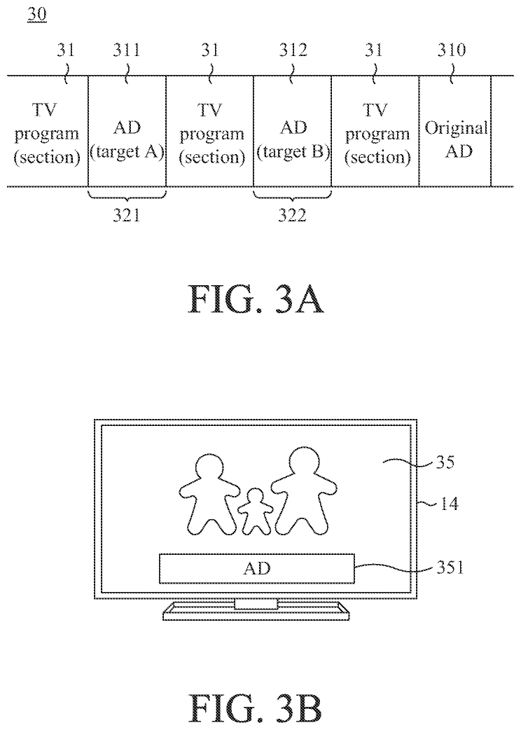

Please refer to FIG. 3A, which is a schematic diagram showing a video stream generated by the set-top box 12. In this embodiment, the video stream 30 (i.e. the information embedded program of the present disclosure) includes TV programs and advertisements 311, 312 inserted in slots 321, 322 between two TV programs or TV program sections 31. To insert the advertisements 311, 312 into the video steam 30, the set-top box 12 should know the proper insertion locations that will not affect viewing the TV programs. The TV program service provider 11 may transmit the broadcast signals together with insertion splice points based on in-band signaling according to SCTE-35 standard. The insertion splice points may indicate available slots or replaceable slots 321, 322 for inserting the advertisements 311, 312. For every available slot or replaceable slot 311, 312, the corresponding advertisement is independently selected according to the predetermined rule. As shown in FIG. 3A, the advertisement 311 selected for target audience group A is inserted in the slot 321, and the advertisement 312 selected for target audience group B is inserted in the slot 322. Through using the insertion splice points, the advertisements 311, 312 can be inserted accurately and seamlessly without covering the TV program sections 31. Besides, the original advertisement 310 in the broadcast signals could be reserved in a specific condition, as shown in FIG. 3A, without being replaced by the interest-based advertisement.

In the embodiment with reference to FIG. 3A, the advertisements 321, 322 are displayed in a full-screen mode. Other modes are shown in FIGS. 3B-3D. An advertisement banner 351, an advertisement button 352, and a pop-up advertisement window 353, are respectively shown in the diagrams. The advertisements 351, 352 and 353 on screen 35 could be shown through picture-in-picture (PIP), on-screen display (OSD) or other known means, and details of the known technologies are not given herein. The TV program service provider 11 could designate the position, size and/or advertising time of each advertisement 351, 352, 353 contained in the broadcast signals to be transmitted to the set-top box 12 based on in-band signaling to ensure the visual effect. In another embodiment, the advertisements could be shown when the set-top box 12 is just started up, the viewer opens an option menu or the viewer takes a specific operation action on the set-top box 12 without adversely covering the current TV program. It is to be noted that any concept revealed in the description with reference to FIG. 1 and FIGS. 3A-3D is applicable, solely or in combination, to these advertisement insertion modes.

The file format of the information-push file need not be a video file as described above. In addition, the file format could include an audio file, an image file, a text file, a multimedia file, an ultrasonic signal file or a combination thereof, and the information content of the information-push file could include an advertisement, a public notification, a quick response code (QR code), an ultrasonic coding signal or a program code and/or information data used with the program code. Therefore, the information embedded system and the information embedded method are not applied to advertising purposes only. For example, the information content could be local, regional or demassified notification issued from a government institution or a specific organization and delivered by the TV program service provider 11. When the information-push file is a text file, the information content may be in the form of a scrolling text. When the information-push file includes a program code and the related information data, a portion of the information content is changeable based on the program code. For example, the information content may represent a coupon, and the information data may relate to discount, expiration date, designated branch store or any changeable item determined by the program code according to the playout region, the broadcast date or the target customer.

In the above embodiments, the information-push files are transmitted from the TV program service provider 11 to the set-top box 12 through the unidirectional transmission medium 13. In another case, the information-push files are stored in an external storage device 122 (FIG. 1) such as a memory card or a flash drive. The TV program service provider 11 regularly provides the program subscribers with the external storage device 122 storing the latest information-push files therein. When the external storage device 122 is electrically coupled to the set-top box 12, the set-top box 12 can directly access the information-push files from the external storage device 122 while performing the advertising insertion actions as described above. Alternatively, the information-push files stored in the external storage device 122 are accessed by and stored in the internal storage device 121 automatically once the external storage device 122 is electrically coupled to the set-top box 12. Then, the set-top box selects one information-push file to provide the information embedded program as described above

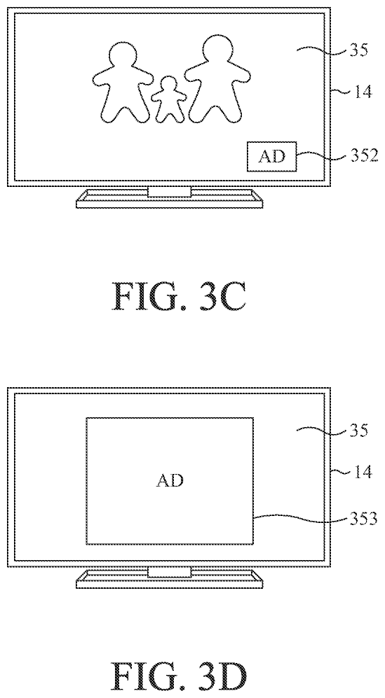

The set-top box 12 and the TV set 14 are usually separately set, but close to each other. Therefore, the function and elements of the set-top box 12 can be integrated into the TV set 14. In this situation, as shown in FIG. 4, the broadcast playout device 44 of the present disclosure includes a broadcast signal receiver 441, a storage device 442, a processing unit 443 and an output device 444. The broadcast signal receiver 441 receives and stores the information-push files in the storage device 442 during the first time period, and receives the broadcast signals through the unidirectional transmission medium during the second time period posterior to the second time period. The processing unit 443 selects one of the information-push files according to the predetermined rule, and combines the broadcast signals and the information content of the selected information-push file to form the information embedded program. The output device 444 receives the information embedded program from the processing unit 443 and reproduces the information embedded program for viewers.

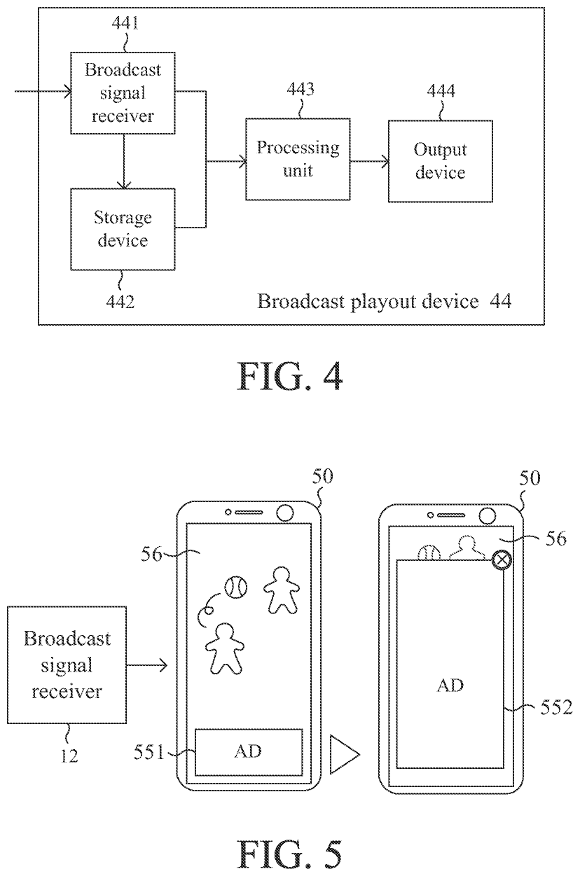

The present disclosure could be enhanced with the use of a smartphone. Please refer to FIG. 5, which is a schematic diagram illustrating the use of a smartphone in the information embedded method and the information embedded system according to an embodiment of the present disclosure. The smartphone 50 is electrically coupled to the set-top box 12 through a wireless network, e.g. Wi-Fi, to download the information embedded program or just the information-push file(s). When the smartphone 50 receives and reproduces the information embedded program on its screen 56, the smartphone 50 functions as the broadcast playout device 14 as described above. The advertisement 551 could be shown through picture-in-picture (PIP), on-screen display (OSD) or other known means at any designated position of the screen 56. If the user is interested in or curious about the advertisement content and would like to see more details, he or she can tap the advertisement portion to open an enlarged advertisement window 552. Furthermore, hyperlinks could be provided in the advertisement so that the user can link to a corresponding file in the set-top box 12 or an external website to obtain more information.

In another embodiment, the information content of the information-push file could be a machine-readable optical label such as a quick response code. The quick response code contains data for a locator, an identifier or a tracker that points to a specific website or application. When the user uses the smartphone 50 to scan the quick response code shown on TV set 14, the data contained in the quick response code guides the smartphone 50 to read a corresponding file in the set-top box 12 or link to an external website to obtain more information. The quick response code or the hyperlink may further contain a user code associated with an individual TV program subscriber so that the advertisement provider can learn about the advertising effect by analyzing the web site visitors based on the user code. In an embodiment, the set-top box 12 can record the website visiting action through the hyperlink or the quick response code to improve or update the audience profile to achieve precise advertisement targeting.

A particular type of an invisible label is introduced herein. Since the smartphone 50 includes a sound receiving element such as a microphone capable of receiving sound waves, the data transmitted to the smartphone 50 can be carried through a sound wave, especially an ultrasonic signal. The frequencies, signal durations or other wave properties of the ultrasonic signal can be used to encode the hyperlink, e.g. in Morse code. The ultrasonic signal carrying the coding data is called ultrasonic coding signal herein. In this embodiment, the TV program and the ultrasonic coding signal are combined to form the information embedded program. The TV set 14 reproduces the information embedded program and thus issues the ultrasonic coding signal (i.e. the information content of the selected information-push file of the present disclosure) at a proper time point. When the smartphone 50 approaches the TV set 14 and receives the ultrasonic coding signal, a specific APP executed in the smartphone 50 can convert the ultrasonic coding signal into a hyperlink with or without a brief introduction, leading to the advertisement page. Since the ultrasonic coding signal exceeds the audible limit of human hearing, it does not affect the viewing the TV program. The set-top box 12 or the TV set 14 could further inform the viewer to start the specific APP to decode the ultrasonic coding signal while issuing the ultrasonic coding signal. The data carried by the ultrasonic coding signal is alterable to meet the individual requirement and is not limited to the embodiment.

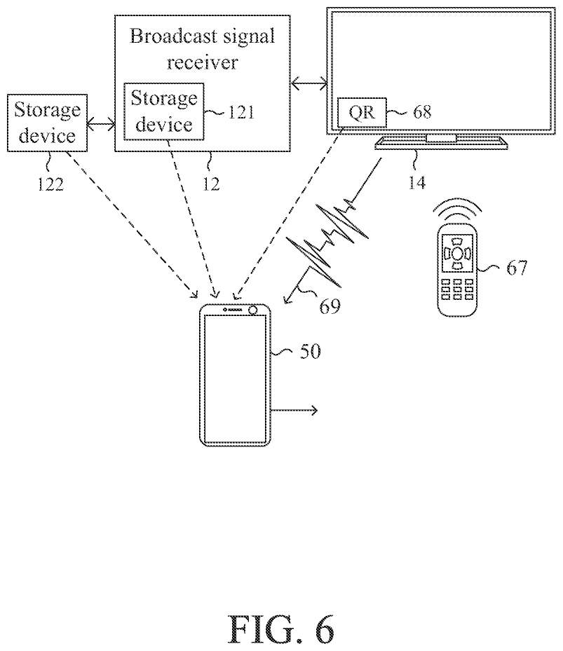

Please refer to FIG. 6, which shows that the present disclosure is applied to distance learning. In the embodiment, the broadcast content is a teaching program and the information contents of the information-push files include various versions of quizzes, homework or key points corresponding to the teaching program. The information push files are transmitted to the set-top box 12 and stored in the internal storage device 121 in advance, or stored in the portable storage device 122 electrically coupled to the set-top box 12. For example, the teaching program is related to chapter three of third-grade science, and the quizzes, homework or key points about this part are provided by respective classes, schools or education systems.

Taking the quiz as an example, after broadcasting the teaching program or a designated section of the teaching program, the set-top box 12 selects one information-push file and outputs the corresponding version of the quiz through the TV set 14 according to the student status recorded or registered in the set-top box 12. The student answers the questions in the selected quiz by operating a remoter controller 67 (e.g. using arrow keys or numeral keys) of the set-top box 12 or the TV set 14 which supports the input operation. In an embodiment, the input information obtained through the remote controller 67 is stored in the internal storage device 121 or the portable storage device 122. Then, the input information stored in the internal storage device 121 can be read out and transmitted to a designated web site via a mobile device (e.g. a smartphone 50) according to any know data transfer method, data transfer protocol and data transfer standard (e.g. 3G, 4G, 5G for cellular network) within a specified time limit (e.g. in few days). Alternatively, the portable storage device 122 is removed from the set-top box 12 and electrically connected to a computer (not shown) to read the input information. Then, the input information is transmitted to the designated web site through the computer and the network. For example, the website is provided by each school or is a distance learning-related website, and the website collects the students' answers. Thus, the teacher can realize the teaching effect for each student by scoring the received answers.

In another embodiment, the processing unit of the set-top box 12 or the TV set 14 converts the received input together with a locator (e.g. Uniform Resource Locator (URL)) into a machine-readable label in an optical form or a sound wave such as the quick response code 68 or the ultrasonic coding signal 69 as described in the above embodiments. Then, the TV set 14 outputs the machine-readable label. If the machine-readable label is a quick response code, the TV set 14 shows the quick response code 68 on screen. The student or parents can use the smartphone 50 to quickly scan the quick response code, acquire the input information and transmit the input information to the designated web site without manually entering the input information or the address of the designated website. The website collects the input information (e.g. answers given by students) for later use. A similar concept is applicable to using the ultrasonic coding signal 69, and a detailed description is not further given herein.

The information embedded system and the information embedded method used with a mobile device can achieve quasi-bidirectional transmission to provide simple feedbacks. The feedback input can be converted into a machine-readable label transmitted in a nonelectrical form and recognizable to the mobile device. By such characteristics, the information embedded system and the information embedded method need little network requirement and can be widely used in many fields when network communication is expensive or not quite ready. The application is not limited to the distance learning field and can be applied to any other situation, e.g. opinion polls for different age ranges, wherein a machine-readable label is considered enough to carry the input information.

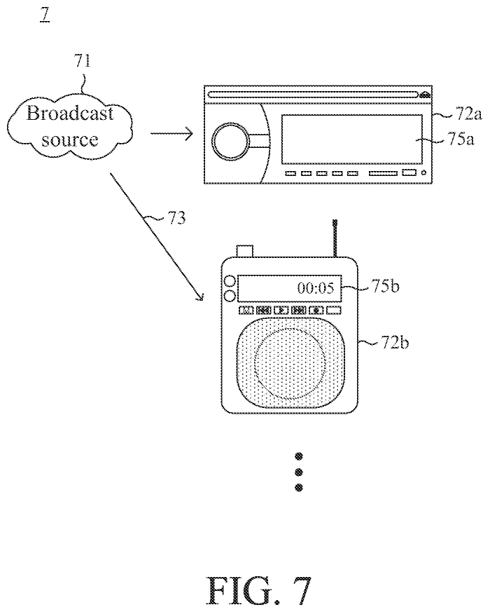

In addition to the television broadcasting, the concept of the present disclosure could be applied to radio broadcasting. Please refer to FIG. 7, which is a schematic diagram illustrating an information embedded system for radio broadcasting according to an embodiment of the present disclosure. The information embedded system 7 includes a broadcast source 71 and broadcast signal receivers 72a, 72b. The broadcast source 71 transmits broadcast signals to the broadcast signal receivers 72a, 72b through a unidirectional transmission medium 73 in a one-to-many manner. For example, the broadcast source 71 is a radio program service provider. The broadcast signals are radio signals but are not limited to these. The broadcast signal receivers may include an automotive audio system 72a disposed in a vehicle or a radio 72b. Each of the broadcast signal receivers 72a, 72b can convert the broadcast signals into radio program content and further function as a broadcast playout device to output the radio program content through a speaker (not shown) of the broadcast signal receiver 72a, 72b. The unidirectional transmission medium 73 could be implemented by radio waves.

The information embedded method for radio broadcasting is similar to that for television broadcasting, and is described in a few words. Most of the concepts described in the above embodiments can be applied to herein without departing from the present disclosure.

In the embodiment, the automotive audio system 72a serving as the broadcast signal receiver is illustrated. At first, the radio program service provider 71 transmits information-push files representing various types of advertisements to the automotive audio system 72a. The information-push files are transmitted through an idle channel or a dedicated channel based on out-of-band signaling or a broadcast channel for the broadcast signals based on in-band signaling. A multiplexer could be used for controlling the transmission of the broadcast signals to be listened to in a first time period and the information-push files to be viewed or listened in a second time period posterior to the first time period. The information-push files are stored in an internal storage device (not shown) of the automotive audio system 72a for later use. For inserting a specific advertisement, the automotive audio system 72a selects one information-push file previously stored in the internal storage device according to a predetermined rule, e.g. a playout region (i.e. the current position of the vehicle), a broadcast time or an audience profile, and combines the radio program content and the information content of the selected information-push file. The audience profile could be obtained from the feedback from the owner of the vehicle. The information-push file could be an audio file, an image file, a video file, a text file, a multimedia file, an ultrasonic signal file or a combination thereof. If the information-push file is an audio file, the audio file is inserted in a slot between two radio program sections. On the other hand, the other format such as image file, video file, text file and multimedia file can be shown on a screen 75a of the automotive audio system 72a, as described in the above embodiments. With regard to a conventional radio 72b just having a simple text display window 75b, a text file is applicable to showing a scrolling text.

In conclusion, the information embedded method and the information embedded system of the present disclosure prestore the information-push files in the storage device of the broadcast signal receiver. The selection of the information-push files to be combined with the broadcast program is made according to the predetermined rule by respective broadcast signal receivers, but not the broadcast source. Hence, the information content can target different groups to avoid a great amount of ineffective advertising even though the broadcasting only supports unidirectional signal transmission.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. An information embedded method used with a broadcast source and a broadcast signal receiver using a unidirectional transmission medium, the information embedded method comprising steps:
storing a plurality of information-push files in the broadcast signal receiver during a first time period;
the broadcast source delivering broadcast signals to the broadcast signal receiver through the unidirectional transmission medium during a second time period posterior to the first time period; and
the broadcast signal receiver selecting one of the information-push files according to a predetermined rule and combining the broadcast signals and information content of the selected information-push file to form an information embedded program.

2. The information embedded method according to claim 1, wherein the broadcast source transmits the information-push files to the broadcast signal receiver through an idle channel or a dedicated channel of the unidirectional transmission medium during the first time period, and the broadcast signal receiver receives and stores the information-push files into an internal storage device of the broadcast signal receiver.

3. The information embedded method according to claim 2, wherein the broadcast signal receiver receives and stores the information-push files in a background process in a sleep mode or an active mode of the broadcast signal receiver.

4. The information embedded method according to claim 1, wherein the information-push files are stored in the broadcast signal receiver through an external storage device.

5. The information embedded method according to claim 1, wherein the broadcast source is an audio program source, a video program source or a combination thereof.

6. The information embedded method according to claim 5, wherein the broadcast signals are provided by a television station of a cable television, a terrestrial television or a satellite television or a radio station, and the unidirectional transmission medium is implemented by a cable or radio waves.

7. The information embedded method according to claim 6, wherein the selected information-push file is an audio file, an image file, a video file, a text file, a multimedia file, an ultrasonic signal file or a combination thereof, and the information content comprises an advertisement, a public notification, a quiz or homework in distance learning, a quick response code, an ultrasonic coding signal, a program code, information data related to the program code or a combination thereof.

8. The information embedded method according to claim 7, further comprising a step of outputting the information embedded program through a broadcast playout device, wherein the information content is shown on the broadcast playout device in a picture-in-picture mode or on a pop-up window, or the information content is inserted in a slot between two program sections or shown on the broadcast playout device in response to starting up the broadcast signal receiver, opening an option menu or operating the broadcast signal receiver.

9. The information embedded method according to claim 8, wherein the broadcast signals delivered from the broadcast source comprise insertion splice points for inserting the information content or a position on the broadcast playout device for showing the information content.

10. The information embedded method according to claim 8, wherein the broadcast signal receiver selects the information-push file according to a playout region, a broadcast time or an audience profile corresponding to the broadcast playout device.

11. The information embedded method according to claim 8, further comprising steps of:
the broadcast signal receiver or the broadcast playout device receiving an input from a remote controller and converting the input into a machine-readable label;
outputting the machine-readable label through the broadcast playout device;
reading the machine-readable label through a mobile device to acquire input information; and
the mobile device transmitting the acquired input information to a designated web site via a network.

12. The information embedded method according to claim 8, further comprising a step of:
the broadcast signal receiver receiving an input from a remote controller and storing the input into a storage device.

13. An information embedded system comprising:
a broadcast source delivering broadcast signals through a unidirectional transmission medium during a second time period; and
a broadcast signal receiver comprising a storage device, the broadcast signal receiver receiving the broadcast signals through the unidirectional transmission medium, receiving and storing a plurality of information-push files in the storage device of the broadcast signal receiver during a first time period prior to the second time period, selecting one of the information-push files according to a predetermined rule, and combining the broadcast signals and information content of the selected information-push file to form an information embedded program.

14. The information embedded system according to claim 13, wherein the broadcast source transmits the information-push files to the broadcast signal receiver through an idle channel or a dedicated channel of the unidirectional transmission medium during the first time period, and the broadcast signal receiver receives and stores the information-push files into an internal storage device of the broadcast signal receiver.

15. The information embedded system according to claim 13, wherein the information-push files are stored in the broadcast signal receiver through an external storage medium.

16. The information embedded system according to claim 13, wherein the broadcast source is an audio program source, a video program source or a combination thereof.

17. The information embedded system according to claim 16, wherein the selected information-push file is an audio file, an image file, a video file, a text file, a multimedia file, an ultrasonic signal file or a combination thereof, the information content comprises an advertisement, a public notification, a quiz or homework in distance learning, a quick response code, an ultrasonic coding signal, a program code, information data related to the program code or a combination thereof, and the broadcast signal receiver selects the information-push file according to a playout region, a broadcast time or an audience profile.

18. The information embedded system according to claim 16, wherein the broadcast signals are provided by a television station of a cable television, a terrestrial television or a satellite television or a radio station, and the unidirectional transmission medium is implemented by a cable or radio waves.

19. The information embedded system according to claim 18, further comprising a broadcast playout device reproducing the information embedded program.

20. The information embedded system according to claim 19, wherein the broadcast signal receiver and the broadcast playout device comprises a set-top box and a television set.

21. The information embedded system according to claim 19, wherein the broadcast signal receiver and the broadcast playout device comprises an automotive audio system or a radio having an information screen.

22. The information embedded system according to claim 19, wherein the broadcast signal receiver receives an input from a remote controller, wherein
the broadcast signal receiver converts the input into a machine-readable label, and outputs the machine-readable label through the broadcast playout device; or
the broadcast signal receiver stores the input into the storage device.

23. A broadcast playout device with an information-push function, comprising:
a storage device for storing a plurality of information-push files received during a first time period;
a broadcast signal receiver for receiving broadcast signals from a broadcast source through a unidirectional transmission medium during a second time period posterior to the first time period;
a processing unit for selecting one of the information-push files stored in the storage device according to a predetermined rule and combining the broadcast signals and information content of the selected information-push file to form an information embedded program; and
an output device for receiving the information embedded program from the processing unit and reproducing the information embedded program.

24. The broadcast playout device according to claim 23, wherein the selected information-push file is an audio file, an image file, a video file, a text file, a multimedia file, an ultrasonic signal file or a combination thereof, and the information content comprises an advertisement, a public notification, a quiz or homework in distance learning, a quick response code, an ultrasonic coding signal, a program code, information data related to the program code or a combination thereof.

25. The broadcast playout device according to claim 24, wherein the broadcast playout device comprises a set-top box and a television set, wherein the storage device, the broadcast signal receiver and the processing unit are integrated in the set-top box, and the output device is the TV set.

26. The broadcast playout device according to claim 25, wherein the information content is shown in a picture-in-picture mode or on a pop-up window, or the information content is inserted in a slot between two program sections or shown on the output device in response to starting up the broadcast signal receiver, opening an option menu or operating the broadcast signal receiver.

27. The broadcast playout device according to claim 24, wherein the broadcast playout device is a television set having the storage device, the broadcast signal receiver and the processing unit.

28. The broadcast playout device according to claim 24, wherein the broadcast playout device is a radio or an automotive audio system, and the information content is shown on a screen of the radio or the automotive audio system, or the information content is inserted in a slot between two radio program sections.

29. The broadcast playout device according to claim 24, wherein the processing unit selects the information-push file according to a playout region, a broadcast time or an audience profile corresponding to the broadcast playout device.

30. The broadcast playout device according to claim 23, wherein the processing unit receives an input from a remote controller, wherein
the processing unit converts the input into a machine-readable label, and outputs the machine-readable label through the output device; or
the broadcast signal receiver stores the input into the storage device.

31. A broadcast source of an information embedded system, the broadcast source comprising a broadcast signal transmitter for delivering broadcast signals and a plurality of information-push files to a broadcast signal receiver through a unidirectional transmission medium, wherein
the information-push files are transmitted to the broadcast signal receiver through an idle channel or a dedicated channel of the unidirectional transmission medium during a first time period, and the broadcast signals are transmitted to the broadcast signal receiver through a broadcast channel of the unidirectional transmission medium during a second time period posterior to the first time period, and
the broadcast signals comprise insertion splice points or display position for inserting information content of one of the information-push files into broadcast content of the broadcast signals.

32. An information delivery method, used with a broadcast source and a broadcast signal receiver using a unidirectional transmission medium, the information delivery method comprising steps:
storing a plurality of information-push files in the broadcast signal receiver during a first time period;
the broadcast source delivering broadcast signals to the broadcast signal receiver through the unidirectional transmission medium during a second time period posterior to the first time period; and
downloading one of the information-push files from the broadcast signal receiver according to a predetermined rule through a portable electronic device.
